(19) United States
(12) Patent Application Publication
(10) Pub. No.: US 2024/0217067 A1
(43) Pub. Date: Jul. 4, 2024

(54) Mountable Support And Vice Device And Method Of Use

(71) Applicants: Christopher Magee, Vidoe, TX (US); Kirk Brian Mullins, III, Vidor, TX (US); Justin Fletcher, Vidor, TX (US)

(72) Inventors: Christopher Magee, Vidoe, TX (US); Kirk Brian Mullins, III, Vidor, TX (US); Justin Fletcher, Vidor, TX (US)

(21) Appl. No.: 18/090,627

(22) Filed: Dec. 29, 2022

(51) Int. Cl. B25B 1/24; B25B 1/20

(52) U.S. Cl. CPC B25B 1/2484; B25B 1/205

(57) ABSTRACT

A mountable support and vice device for field use in small work areas includes a fastener, which is attached to a first terminus of a rod. The fastener is selectively attachable to an element of a structure, such as a scaffold, to removably attach the rod to the element of the structure. A pipe is nested around the rod so that the pipe is selectively extensible from, and selectively rotatable relative to, the rod. A coupler attached to the pipe and is positioned to selectively couple to the rod so that the pipe is fixedly positioned relative to the rod and the element of the structure. A vice is attached to the pipe proximate to a first end of the pipe and can selectively grip a substrate, such as a pipe elbow. The substrate thus is fixedly positioned and can be manipulated by a user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to vice supports and more particularly pertains to a new vice support for field use in small work areas. The present invention discloses a vice support having a rod that is attachable to an element of a structure and a pipe bearing a vice that is positioned around the rod. The pipe is selectively extensible and rotatable relative to the rod.

### (2) Description of Related Art Including Information Disclosed Under 37 CFR 1.97 and 1.98

The prior art relates to vice supports, which may comprise vices having tripodal bases or four legged bases, such as sawhorse bases, and tiltable bench mounted vices. The prior art does not teach a vice support comprising a rod which is attachable to a structure and around which is positioned a pipe bearing a vice.

### BRIEF SUMMARY OF THE INVENTION

An embodiment of the disclosure meets the needs presented above by generally comprising a fastener, which is attached to a first terminus of a rod. The fastener is configured for selective attachment to an element of a structure, such as a scaffold, to removably attach the rod to the element of the structure. A pipe is nested around the rod so that the pipe is selectively extensible from, and selectively rotatable relative to, the rod. A coupler attached to the pipe and is positioned to selectively couple to the rod so that the pipe is fixedly positioned relative to the rod and the element of the structure. A vice is attached to the pipe proximate to a first end of the pipe and is configured to selectively grip a substrate, such as a pipe elbow. The substrate thus is fixedly positioned and can be manipulated by a user.

Another embodiment of the disclosure includes a method of gripping and supporting a substrate. The method comprises a provision step, which entails providing a mountable support and vice device 10, according to the disclosure above. Executing the method entails attaching the rod to the element of the structure using the fastener, gripping a substrate with the vice, extending the pipe to a desired position, rotating the pipe to position the substrate, and coupling the pipe to the rod using the coupler.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a mountable support and vice device according to an embodiment of the disclosure.

FIG. 2 is an in-use view of an embodiment of the disclosure.

FIG. 3 is a front view a side view of an embodiment of the disclosure.

FIG. 4 is rear view of an embodiment of the disclosure.

FIG. 5 is a side view of an embodiment of the disclosure.

FIG. 6 is a flow diagram for a method utilizing an embodiment of the disclosure.

### DETAILED DESCRIPTION OF THE INVENTION

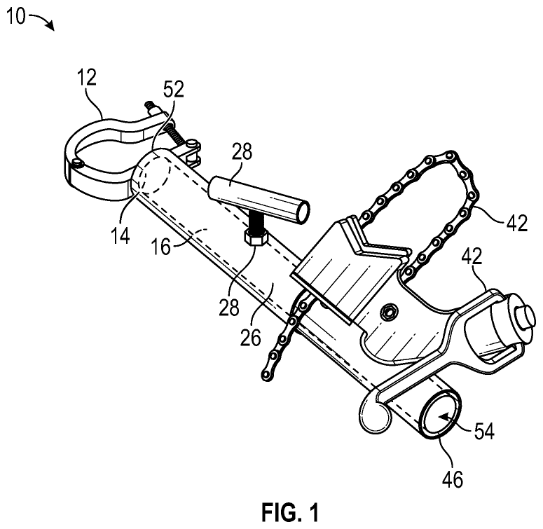

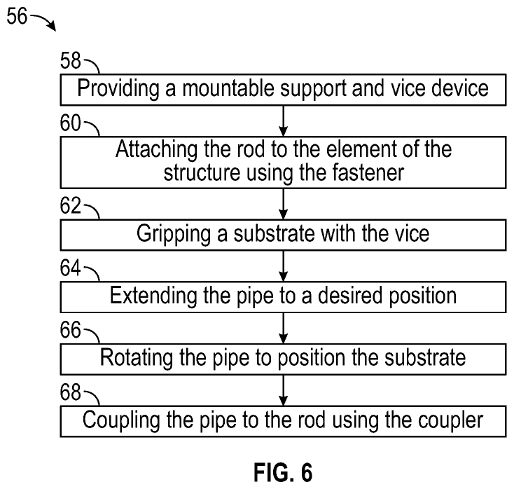

With reference now to the drawings, and in particular to FIGS. 1 through 6 thereof, a new vice support embodying the principles and concepts of an embodiment of the disclosure and generally designated by the reference numeral 10 will be described.

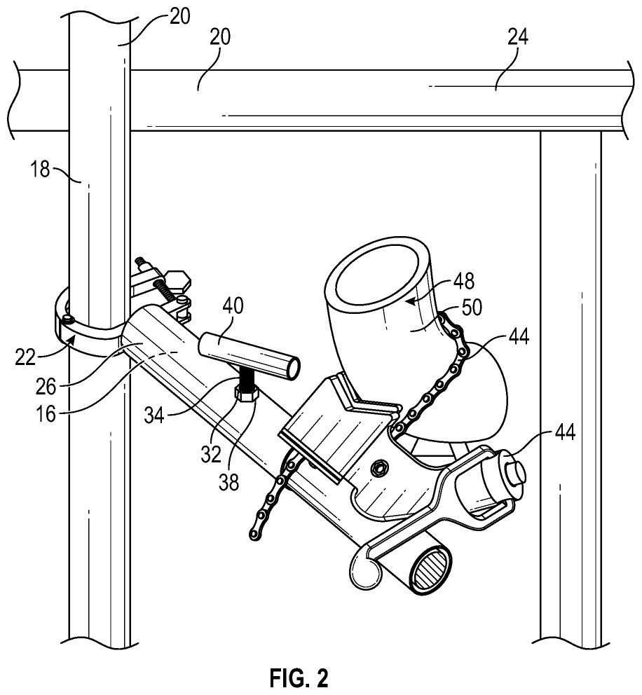

As best illustrated in FIGS. 1 through 6, the mountable support and vice device 10 generally comprises a fastener 12, which is attached to a first terminus 14 of a rod 16, as shown in FIGS. 1-2. The fastener 12 is configured for selective attachment to an element 18 of a structure 20 to removably attach the rod 16 to the element 18 of the structure 20. The first fastener 12 comprises a clamp 22 attached to the rod 16 such that the rod 16 extends substantially perpendicularly from the element 18 of the structure 20, such as a scaffold 24, upon fastening of the clamp 22 to the element 18. A pipe 26 is nested around the rod 16 so that the pipe 26 is selectively extensible from, and selectively rotatable relative to, the rod 16.

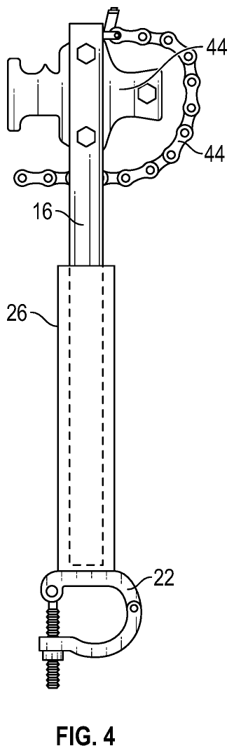

A coupler 28 attached to the pipe 26 and is positioned to selectively couple to the rod 16 so that the pipe 26 is fixedly positioned relative to the rod 16 and the element 18 of the structure 20. The coupler 28 may comprise a threaded hole 30, which is positioned in the pipe 26, and a bolt 32, which is threadedly inserted into the threaded hole 30. A head 34 of the bolt 32 is configured to be turned so that a terminus 36 of the bolt 32 frictionally engages the rod 16 to fixedly position the pipe 26 relative to the rod 16 and the element 18 of the structure 20. As shown in FIG. 4, the threaded hole 30 may comprise a nut 38 that attached to the pipe 26.

The coupler 28 also may comprise a tube 40, as shown in FIG. 1, a knob, or the like, which is attached to the head 34 of the bolt 32. The tube 40 is configured to be grasped in a hand of a user, positioning the user to turn the bolt 32. The present invention anticipates the coupler 28 comprises other coupling means, such as, but not limited to, twist lock connectors, cam locks, and the like.

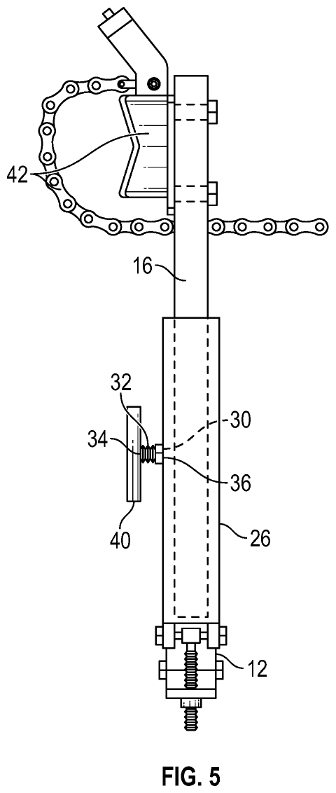

A vice 42, such as a chain pipe vice 44, as shown in FIG. 1-5, a hinged pipe vice, or the like, is attached to the pipe 26 proximate to a first end 46 of the pipe 26 and is configured to selectively grip a substrate 48. The substrate 48 thus is fixedly positioned and can be manipulated by a user. For example, as shown in FIG. 5, a pipe elbow 50 is gripped by the vice 42 and is stabilized for welding. The user can, as needed, release the coupler 28 and rotate the pipe 26 to reposition the substrate 48.

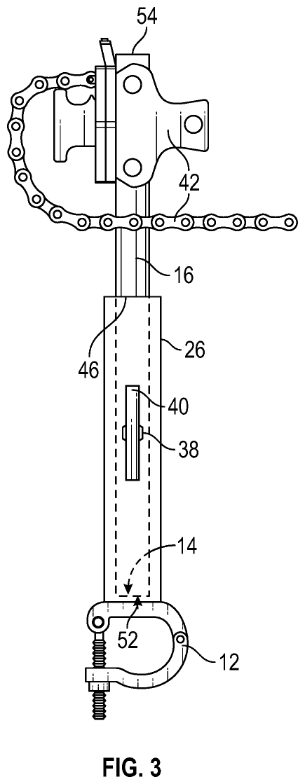

Another configuration of the mountable support and vice device 10 is shown in FIGS. 3-5, wherein the fastener 12 is attached to a second end 52 of the pipe 26 and the vice 42 is attached to a second terminus 54 of the rod 16.

In use, the mountable support and vice device 10 enables a method of gripping and supporting a substrate 56. The method 56 comprises a provision step 58, which entails providing a mountable support and vice device 10, according to the specification above. A mounting step 60 of the method 56 is attaching the rod 16 to the element 18 of the structure 20 using the fastener 12. An attachment step 62 of the method 56 is gripping a substrate 48 with the vice 42. A first positioning step 64 of the method 56 is extending the pipe 26 to a desired position. A second positioning step 66 of the method 56 is rotating the pipe 26 to position the substrate 48. A locking step 68 of the method 56 is coupling the pipe 26 to the rod 16 using the coupler 28. The substrate 48 thus is fixedly positioned and can be manipulated by a user.

The mountable support and vice device 10 is compact, readily transported, and can be utilized in locations, such as upon a scaffold 24, where it is otherwise difficult to fixedly position a substrate 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mountable support and vice device comprising:
a rod;
a fastener attached to a first terminus of the rod, the fastener being configured for selective attachment to an element of a structure, wherein the fastener is configured for removably attaching the rod to the element of the structure;
a pipe nested around the rod, such that the pipe is selectively extensible from, and selectively rotatable relative to, the rod;
a coupler attached to the pipe and being positioned for selectively coupling to the rod, such that the pipe is fixedly positioned relative to the rod and the element of the structure; and
a vice attached to the pipe proximate to a first end of the pipe, wherein the vice is configured for selectively gripping a substrate.

2. The mountable support and vice device of claim 1, wherein the first fastener comprises a clamp attached to the rod such that the rod extends substantially perpendicularly from the element of the structure upon fastening of the clamp to the element.

3. The mountable support and vice device of claim 1, wherein the coupler comprises:
a threaded hole in the pipe; and
a bolt threadedly inserted into the threaded hole, wherein a head of the bolt is configured for being turned, such that a terminus of the bolt frictionally engages the rod for fixedly positioning the pipe relative to the rod and the element of the structure.

4. The mountable support and vice device of claim 1, wherein the threaded hole comprises a nut attached to the pipe.

5. The mountable support and vice device of claim 1, further including a tube attached to the head of the bolt, wherein the rod is configured for grasping in a hand of a user, positioning the user for turning the bolt.

6. The mountable support and vice device of claim 1, wherein the vice comprises a chain pipe vice.

7. The mountable support and vice device of claim 1, wherein the fastener is attached to a second end of the pipe and the vice is attached to a second terminus of the rod.

8. A mountable support and vice device comprising:
a rod;
a fastener attached to a first terminus of the rod, the fastener being configured for selective attachment to an element of a structure, wherein the fastener is configured for removably attaching the rod to the element of the structure, the first fastener comprising a clamp attached to the rod such that the rod extends substantially perpendicularly from the element of the structure upon fastening of the clamp to the element;
a pipe nested around the rod, such that the pipe is selectively extensible from, and selectively rotatable relative to, the rod;
a coupler attached to the pipe and being positioned for selectively coupling to the rod, such that the pipe is fixedly positioned relative to the rod and the element of the structure, the coupler comprising:
a threaded hole in the pipe, the threaded hole comprising a nut attached to the pipe,
a bolt threadedly inserted into the threaded hole, wherein a head of the bolt is configured for being turned, such that a terminus of the bolt frictionally engages the rod for fixedly positioning the pipe relative to the rod and the element of the structure, and
a tube attached to the head of the bolt, wherein the rod is configured for grasping in a hand of a user, positioning the user for turning the bolt; and
a vice attached to the pipe proximate to a first end of the pipe, wherein the vice is configured for selectively gripping a substrate, the vice comprising a chain pipe vice.

9. The mountable support and vice device of claim 8, wherein:
the fastener is attached to a second end of the pipe; and
the vice is attached to a second terminus of the rod.

10. A method of gripping and supporting a substrate comprising the steps of:
providing a mountable support and vice device comprising:
a rod,
a fastener attached to a first terminus of the rod, the fastener being configured for selective attachment to an element of a structure,
a pipe nested around the rod, such that the pipe is selectively extensible from, and selectively rotatable relative to, the rod,
a coupler attached to the pipe and being positioned for selectively coupling to the rod, such that the pipe is fixedly positioned relative to the rod and the element of the structure, and
a vice attached to the pipe proximate to a first end of the pipe, wherein the vice is configured for selectively gripping a substrate;
attaching the rod to the element of the structure using the fastener;
gripping a substrate with the vice;
extending the pipe to a desired position;
rotating the pipe to position the substrate; and
coupling the pipe to the rod using the coupler.
